(19) United States
(12) Patent Application Publication
(10) Pub. No.: US 2019/0284975 A1
(43) Pub. Date: Sep. 19, 2019

(54) LIQUID FILTER MODULE

(71) Applicant: Mahle International GmbH, Stuttgart (DE)

(72) Inventors: Kai Saupe, Boeblingen (DE); Thomas Eichinger, Berglen (DE)

(73) Assignee: Mahle International GmbH, Stuttgart (DE)

(21) Appl. No.: 16/300,564

(22) PCT Filed: Apr. 26, 2017
(86) PCT No.: PCT/EP2017/059933

§ 371 Date: Nov. 10, 2018

(30) Foreign Application Priority Data
May 10, 2016 (DE) 10 2016 208 022.9

(51) Int. Cl. F01M 11/03; B01D 35/18; B01D 35/00; B01D 35/157; F01M 5/00; F16B 19/02

(52) U.S. Cl. CPC F01M 11/03; B01D 35/18; B01D 35/005; B01D 35/1573; F01M 2011/033; F16B 19/02; B01D 2201/342; B01D 2201/4046; F01M 5/002

(57) ABSTRACT

A liquid filter module may include a filter device and a heat exchanger coupled thereto via an intermediate piece. At least one liquid channel and a receiving channel crossing the at least one liquid channel and configured to receive a valve may be disposed in the intermediate piece. The receiving channel may include a channel which crosses the receiving channel and in which a securing element may be arranged which fixes the valve.

### CROSS-REFERENCE TO RELATED APPLICATIONS

This application claims priority to International Patent Application No. PCT/EP2017/059933, filed Apr. 26, 2017, and German Patent Application No. DE 10 2016 208 022.9, filed on May 10, 2016, the contents of both of which are hereby incorporated by reference in their entirety.

### TECHNICAL FIELD

The present invention relates to a liquid filter module having a filter device and a heat exchanger which is coupled thereto by means of an intermediate piece. The invention further relates to an internal combustion engine which is provided with such a liquid filter module.

### BACKGROUND

Generic liquid filter modules are adequately known and generally have a so-called bypass valve which particularly in the cold start phase directs an oil flow around the heat exchanger, that is to say, around the cooler, whereby the pressure drop is lower and consequently the bearing locations are more rapidly supplied with oil.

EP 2 305 360 A1 discloses a generic liquid filter module with a filter device and a heat exchanger which is coupled thereto by means of an intermediate piece, wherein in the intermediate piece at least one liquid channel and a receiving channel which crosses it for receiving a valve are provided. The valve is in this specific case constructed as a bypass valve and secured to the intermediate piece by means of a bayonet closure. An assembly or disassembly of the valve is thereby in particular intended to be simplified.

However, such a bayonet closure for fixing the valve to the intermediate piece is in this instance structurally complex and also costly.

### SUMMARY

The present invention therefore addressees the problem of providing for a liquid filter module of the generic type an improved or at least an alternative embodiment, which in particular is constructed in a simpler manner.

This problem is solved according to the invention by the subject-matter of the independent claim(s). Advantageous embodiments are set out in the dependent claim(s).

The present invention is based on the general notion of no longer using a separate closure device for fixing a valve to an intermediate piece a liquid filter module, but instead an extremely simple securing element which can further carry out an additional function. The liquid filter module according to the invention has in this instance a filter device and a heat exchanger which is coupled thereto by means of an intermediate piece, wherein in the intermediate piece at least one liquid channel and a receiving channel which crosses it for receiving the valve are provided. According to the invention, in order to secure the valve in the receiving channel there is provided a channel which crosses the receiving channel and in which the above-mentioned securing element is arranged. This securing element may, for example, be constructed as a sleeve which is required in any case in order to be able to securely screw the liquid filter module to an internal combustion engine. If such a sleeve were not used, when the screws were tightened the intermediate piece which is constructed from plastics material would not be able to absorb the forces which occur and would be pressed together. Alternatively, of course, there may also be provided a securing element which is constructed as a simple securing pin and which is inserted into the channel without any screwing action and thereby impedes the valve which is inserted in the receiving channel, for example, a bypass valve, from being moved out. This securing pin may in this instance additionally be constructed as a positioning pin which, on the one hand, engages in a recess at an edge of the heat exchanger and, on the other hand, engages in the channel and thereby defines a relative position of the heat exchanger on the intermediate piece. Regardless of the variant selected in each case, however, with the liquid filter module according to the invention no complex securing technology, such as, for example, a bayonet closure, is required for fixing the valve in the receiving channel. Instead, in this regard, in particular in the case of the above-mentioned sleeve, components of the liquid filter module which are present in any case may be provided with an additional function and used to secure the valve in the receiving channel. In particular structural complexity and in addition also the production costs are thereby reduced.

In an advantageous development of the solution according to the invention, the valve has a housing having a wax expansion element which is arranged therein, a spring and an operating piston. The spring is used in this instance to return the operating piston, whilst the wax expansion element brings about in accordance with the temperature an adjustment of the operating piston counter to the resilient force. In place of the wax expansion element, it is, of course, also possible to use a bimetal or a shape-memory alloy.

Advantageously, the housing has a peripheral annular grove in which there is arranged an O-ring seal via which the valve is received in the receiving channel in a fluid-tight manner. Via the O-ring seal which is arranged directly between the housing of the valve and a wall of the receiving channel, a reliable sealing of the valve can be achieved so that, in this instance, a separate lid for tightly closing the receiving channel can be dispensed with. The large number of components and the production costs can thereby be reduced.

Advantageously, the housing has at an end side a guide contour, in particular a transverse groove, in which the securing element at least partially engages. Via this guide contour which may, for example, be constructed as a groove which crosses the end side of the housing, an angularly precise installation position of the valve, in particular the bypass valve, can be enforced in the receiving channel and a reliable fixing of the valve in the receiving channel.

In an advantageous development of the solution according to the invention, the sleeve is at a maximum as long as the height of the intermediate piece. In order, when tightening the screws which fix the liquid filter module to the internal combustion engine, to be able to reliably prevent a compression of the intermediate piece which is constructed from plastics material, there are provided the above-mentioned sleeves whose length substantially corresponds to the height of the intermediate piece and thereby enables a fixing of the liquid filter module to the internal combustion engine without damaging compression of the intermediate piece. In this instance, the length of the sleeve is preferably slightly smaller than the height of the intermediate piece in order to be able to apply a predefined tension to the intermediate piece.

In another advantageous embodiment, the sleeve is the same length as or longer than the height of the intermediate piece. When the sleeve overhangs the height of the intermediate piece, the sleeve may additionally be used as an auxiliary positioning means for an additional unit, preferably a heat exchanger, a filter housing half, etcetera, and consequently replaces an additional positioning of the arranged additional unit.

In another advantageous development of the solution according to the invention, the heat exchanger has a base plate having a through-opening which is arranged at the edge of the base plate and which, when the liquid filter module is mounted, is in alignment with the channel in the intermediate piece. The sleeve and the securing screw which is guided therein can selectively be inserted or screwed through the through-opening and the channel which is in alignment therewith in order to fix the liquid filter module to the internal combustion engine or, however, simply a securing element which is constructed as a positioning pin and which serves exclusively to determine a defined relative position of the heat exchanger with respect to the intermediate piece. In order to be able to bring about a clearly defined installation position, there may additionally also be provided a positioning element which, on the one hand, engages in a recess in the heat exchanger and, on the other hand, in a recess in the intermediate piece and, furthermore, defines a relative position of the heat exchanger on the intermediate piece. Together with the positioning pin or the sleeve, using the positioning element a clear relative position can be enforced. Such a clear relative position simplifies in particular the assembly of the liquid filter module.

In an advantageous development of the solution according to the invention, the intermediate piece constructed from plastics material, in particular as an injection-molded plastics material component. A construction of the intermediate piece as a plastics material injection-molded component enables, on the one hand, a cost-effective production and, on the other hand, at the same time a high-quality production of the intermediate piece.

Other important features and advantages of the invention will be appreciated from the dependent claims, the drawings and from the associated description of the Figures with reference to the drawings.

It will be understood that the features mentioned above and those yet to be explained below can be used not only in the combination set out in each case, but also in other combinations or alone without departing from the scope of the present invention.

Preferred embodiments of the invention are illustrated in the drawings and are explained in greater detail in the following description, wherein identical reference numerals refer to components which are identical or similar or functionally identical.

### BRIEF DESCRIPTION OF THE DRAWINGS

In the schematic drawings,

FIG. 1 shows a liquid filter module according to the invention with an intermediate piece and a sleeve which is provided to fix a valve,

FIG. 2 is a sectioned illustration through the valve,

FIGS. 3A, 3B, and 3C show a possible assembly of the valve in the intermediate piece,

FIG. 4 is a sectioned illustration through the liquid filter module in the region of the valve, but with a plane of section orthogonal with respect to FIG. 2.

### DETAILED DESCRIPTION

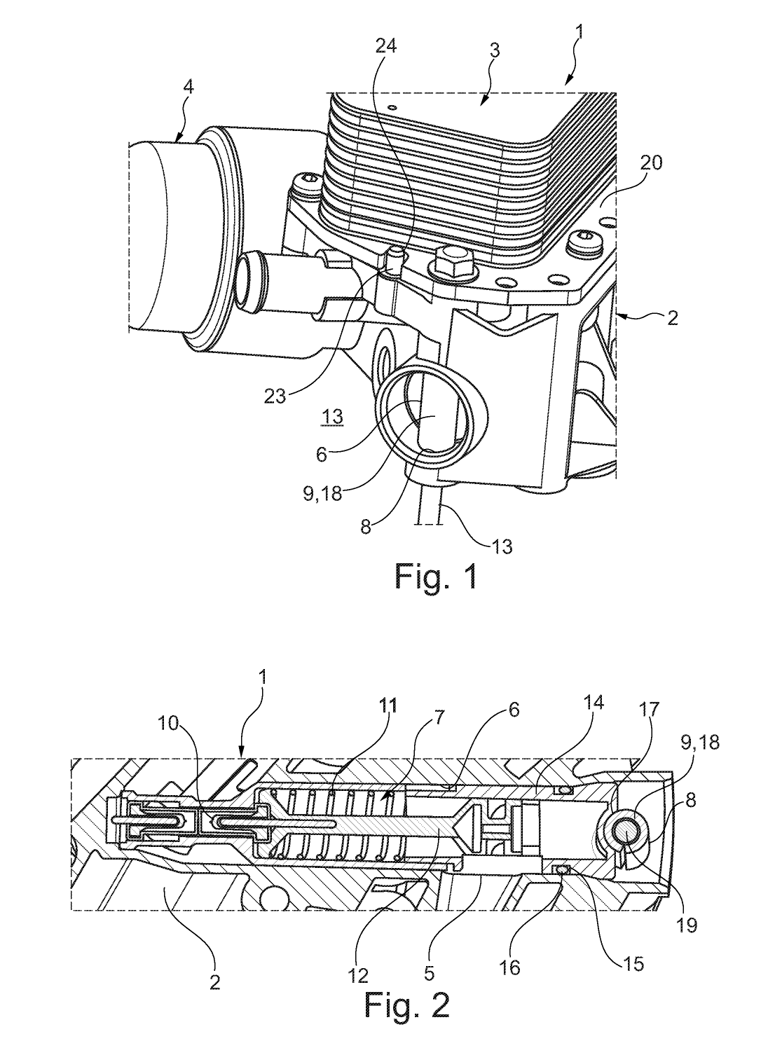

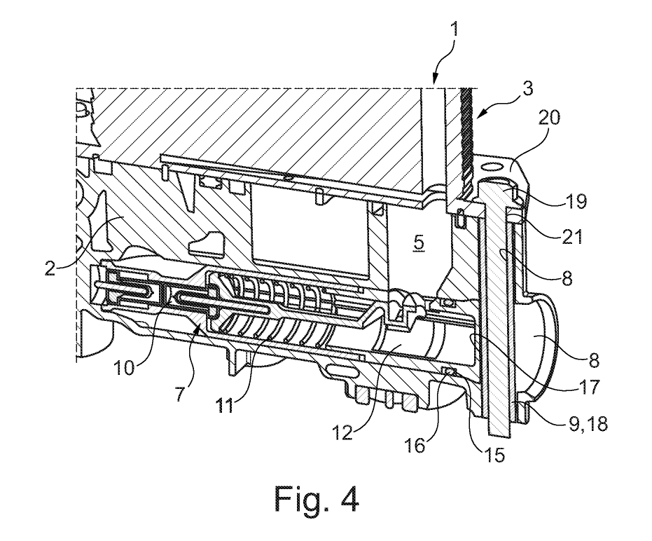

According to FIG. 1, a liquid filter module 1 according to the invention, in particular an oil filter module, has an intermediate piece 2. on which a heat exchanger 3 and a filter device 4 are arranged. The intermediate piece 2 is in this instance constructed from plastics material, in particular as a plastics material injection-molded component. There are provided in the intermediate piece 2 at least one liquid channel 5 (cf. also FIGS. 2 and 4) and a receiving channel 6 which crosses it for receiving a valve 7. In order to secure the valve 7 in the receiving channel 6, there is provided a channel 8 which crosses the receiving channel 6 and in which a securing element 9 is arranged.

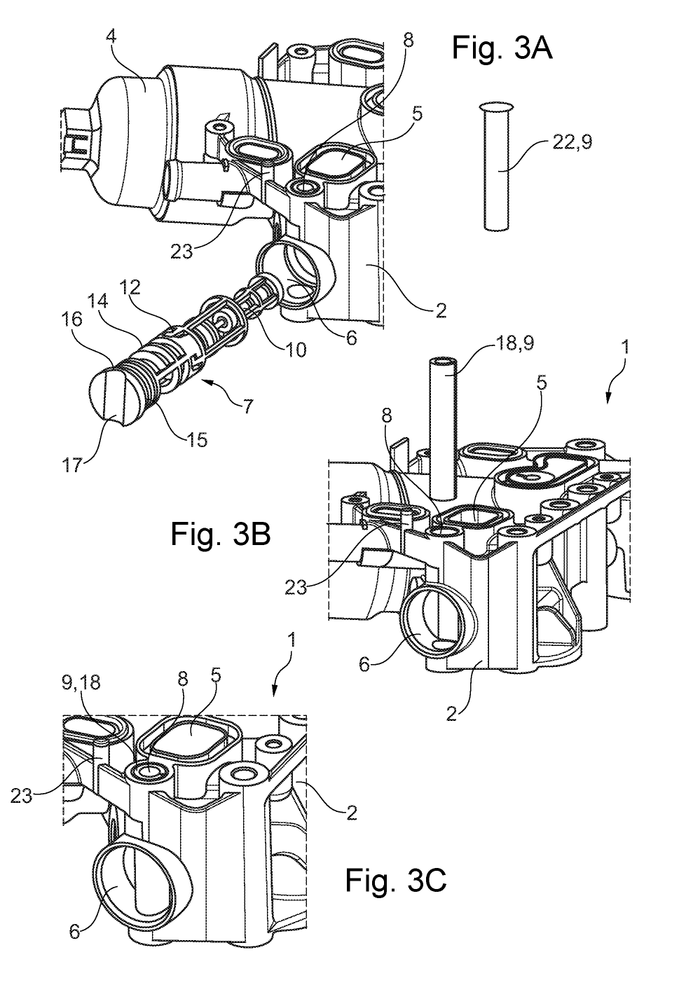

The valve 7 has in this instance a housing 14 having a wax expansion element 10 which is arranged therein, a spring 11 and an operating piston 12. In this instance, the wax expansion element 10 displaces in accordance with the temperature the operating piston 12, whereupon it releases or closes a bypass channel which bypasses the heat exchanger 3. This is particularly significant in the event of a cold start of an internal combustion engine 13 which is provided with the liquid filter module 1 according to the invention. If FIGS. 2 and 3A are taken into consideration in particular, it can be seen that the housing 14 has a peripheral annular groove 15 in which there are arranged an O-ring seal 16 via which the valve 7 is received in the receiving channel 6 in a fluid-tight manner. At an end side of the housing 14, there is provided in this case a guide contour 17, for example, as a groove which extends in the transverse direction and in which the securing element 9 in the assembled state at least partially engages, as can be seen clearly, for example, according to FIG. 2.

In principle, the securing element 9 may, for example, be constructed as a sleeve 18 through which a screw 19 is guided in order to secure the liquid filter module 1 to the internal combustion engine 13. Such a sleeve 18 is in any case provided since a tensioning of the liquid filter module 1 on the internal combustion engine 13 without such a sleeve 18 would lead to an excessive compression of the intermediate piece 2 which is constructed from plastics material and would thereby damage it. The sleeve 18 is in this instance at a maximum as long as the height of the intermediate piece 2, generally slightly shorter, whereby a predefined screwing force and also a predefined pressing force on the intermediate piece 2 can be ensured.

Alternatively, the sleeve 18 may also be the same length as or longer than the height of the intermediate piece 2. When the sleeve 18 overhangs the height of the intermediate piece 2, the sleeve 18 may additionally act as an auxiliary positioning means for an additional unit, preferably a heat exchanger 3, a filter housing half, etcetera, and consequently replaces an additional positioning of the arranged additional unit.

If FIGS. 1 and 4 are taken into consideration, it can be seen that the heat exchanger 3 has a base plate 20 having a through-opening 21 which is arranged at an edge of the base plate 20 and which, when the liquid filter module 1 is mounted, is in alignment with the channel 8. Through this through-opening 21 and the channel 8, on the one hand, the sleeve 18 and the screw 19 are guided, whilst, on the other hand, for example, only a securing element 9 which is constructed as a securing pin 22 is guided. In this case, such a securing pin 22, as illustrated according to FIG. 3A, serves only to fix the valve 7 in the receiving channel 6, but has no fixing action at all to secure the liquid filter module 1 to the internal combustion engine 13.

In addition, there may further be provided a positioning element 23 (cf. FIG. 1) which, on the one hand, engages in a recess 24 in the heat exchanger 3 or in the base plate 20 of the heat exchanger 3 and, on the other hand, in a recess in the intermediate piece 2 and, furthermore, defines a relative position of the heat exchanger 3 with respect to the intermediate piece 2. Together with the securing element 9, regardless of whether a sleeve 18 or securing pin 22 is involved, a precise relative position of the heat exchanger 3 with respect to the intermediate piece 2 can be defined.

With the liquid filter module 1 according to the invention, it is for the first time possible to dispense with additional and sometimes structurally complex securing elements for securing the valve 7 in the receiving channel 8 and to use for this purpose a securing element 9, 18, 22 which is in any case used at least at one other location, whereby the structural complexity and furthermore also the production costs can be reduced.

1. A liquid filter module comprising a filter device and a heat exchanger coupled thereto via an intermediate piece, wherein at least one liquid channel and a receiving channel crossing the at least one liquid channel and configured to receive a valve are disposed in the intermediate piece, and wherein the receiving channel includes a channel which crosses the receiving channel and in which there is arranged a securing element which fixes the valve.

2. The liquid filter module as claimed in claim 1, wherein the valve includes a housing, a wax expansion element arranged within the housing, a spring, and an operating piston.

3. The liquid filter module as claimed in claim 2, wherein the housing includes a peripheral annular groove in which there is arranged an O-ring seal via which the valve is received in the receiving channel of the intermediate piece in a fluid-tight manner.

4. The liquid filter module as claimed in claim 2, wherein the housing includes, at an end side a guide contour in which the securing element is at least partially engaged.

5. The liquid filter module as claimed in claim 1, wherein the securing element is structured as a sleeve through which a screw is guidable to secure the liquid filter module to an internal combustion engine.

6. The liquid filter module as claimed in claim 5, wherein the sleeve has a length equal to or less than a height of the intermediate piece.

7. The liquid filter module as claimed in claim 1, wherein the heat exchanger includes a base plate having a through-opening arranged at an edge of the base plate and which, when the liquid filter module is mounted, is in alignment with the channel.

8. The liquid filter module as claimed in claim 7, wherein one of:
the securing element is structured as a sleeve through which a screw is guidable, and the sleeve and the screw are guided through and arranged in the through-opening and the channel; and
the securing element is structured as a securing pin and is guided through and arranged in the through-opening and the channel.

9. The liquid filter module as claimed in claim 1, wherein at least one of:
the intermediate piece is composed of a plastics material; and
at least one positioning element engages a recess in the heat exchanger and a recess in the intermediate piece, the at least one positioning element defining a relative position of the heat exchanger on the intermediate piece.

10. An internal combustion engine comprising a liquid filter module including a filter device and a heat exchanger coupled thereto via an intermediate piece, wherein at least one liquid channel and a receiving channel crossing the at least one liquid channel are disposed within the intermediate piece, and wherein the receiving channel includes a channel, which crosses the receiving channel, in which a securing element is arranged, the securing element coupling a value within the receiving channel.

11. The internal combustion engine as claimed in claim 10, wherein the valve includes a housing, a wax expansion element arranged within the housing, a spring, and an operating piston.

12. The internal combustion engine as claimed in claim 11, wherein the housing includes a peripheral annular groove and an O-ring seal arranged therein via which the valve is received in the receiving channel of the intermediate piece in a fluid-tight manner.

13. The internal combustion engine as claimed in claim 11, wherein the housing includes, at an end side, a guide contour, and wherein the securing element at least partially engages the guide contour.

14. The internal combustion engine as claimed in claim 10, wherein the securing element is structured as a sleeve through which a screw is guidable to secure the liquid filter module to the internal combustion engine.

15. The internal combustion engine as claimed in claim 14, wherein the sleeve has a length equal to or less than a height of the intermediate piece.

16. The internal combustion engine as claimed in claim 10, wherein the heat exchanger includes a base plate having a through-opening arranged at an edge of the base plate, and wherein the through-opening is aligned with the channel when the liquid filter module is mounted.

17. The internal combustion engine as claimed in claim 16, wherein one of:
the securing element is structured as a sleeve through which a screw is guidable, and the sleeve and the screw are guided through and arranged in the through-opening and the channel; and
the securing element structured as a securing pin and is guided through and arranged in the through-opening and the channel.

18. The internal combustion engine as claimed in claim 10, wherein at least one of:
the intermediate piece is a plastics material; and
at least one positioning element engages a recess in the heat exchanger and a recess in the intermediate piece, the at least one positioning element defining a relative position of the heat exchanger on the intermediate piece.

19. The liquid filter module as claimed in claim 1, wherein the securing element is structured as a securing pin and is guided through and arranged in a through-opening in the heat exchanger and the channel.

20. The liquid filter module as claimed in claim 4, wherein the guide contour is a transverse groove.
